(19) United States
(12) Patent Application Publication
(10) Pub. No.: US 2024/0168136 A1
(43) Pub. Date: May 23, 2024

(54) LIDAR ROTATIONAL SCANNER-INDUCED OFFSET COMPENSATION

(71) Applicant: Luminar Technologies, Inc., Orlando, FL (US)

(72) Inventors: Daniel Joseph KLEMME, Robbinsdale, MN (US); Daniel Aaron MOHR, St. Paul, MN (US)

(21) Appl. No.: 18/511,816

(22) Filed: Nov. 16, 2023

Related U.S. Application Data
(60) Provisional application No. 63/384,210, filed on Nov. 17, 2022.

(51) Int. Cl. G01S 7/481; G01S 7/288; G01S 7/4863; G01S 17/32

(52) U.S. Cl. CPC G01S 7/4817; G01S 7/288; G01S 7/4863; G01S 17/32

(57) ABSTRACT

The technology disclosed herein provides a method of operating a LiDAR system, the method including directing from a light source a distance-measuring beam of light on a target, receiving a reflection of the beam of light from the target on a fast mechanical scanner, compensating for angular offset induced by the fast mechanical scanner within the reflection of the beam of light using an offset compensator, and determining a distance between the light source and the target based on the offset corrected light beam output from the offset compensator and directed to a detector.

### CROSS-REFERENCE TO RELATED APPLICATIONS

This application is a non-provisional application based on and takes priority from pending U.S. provisional application Ser. No. 63/384,210, entitled “LiDAR Rotational Scanner-Induced Offset Compensation,” which was filed on Nov. 17, 2022. The disclosure set forth in the referenced application is incorporated herein by reference in its entirety.

### BACKGROUND

Light detection and ranging (also referred to as laser imaging, detection, and ranging; LiDAR; LIDAR; Lidar; or LADAR) is a method for measuring distances (also referred to as ranging) by illuminating a target with a laser source and measuring a reflection of the laser light with a sensor. Laser return times (e.g., pulsed time of flight) and differences in phase, frequency, and/or wavelength can then be used to estimate a distance between the target and the laser source. Lidar has terrestrial, airborne, and mobile applications.

One application of LiDAR is ranging and detection of objects for control and navigation of autonomous vehicles (e.g., cars, trucks, watercraft, aircraft, and spacecraft). Autonomous vehicle LiDAR is particularly challenging as autonomous vehicle packaging requirements require complex optics to direct the laser source of the LiDAR system. Further, the target size, shape, and relative velocity, and distance to the autonomous vehicle are unknown to the autonomous vehicle LiDAR system. Still further, the location of the target objects within range of the autonomous vehicle LiDAR system are potentially rapidly changing over time. Accordingly, the presently disclosed technology functions to extend the dynamic range and accuracy of prior art LiDAR systems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

The technology disclosed herein provides a method of operating a LiDAR system, the method including directing from a light source a distance-measuring beam of light on a target, receiving a reflection of the beam of light from the target on a fast mechanical scanner, compensating for angular offset induced by the fast mechanical scanner within the reflection of the beam of light using an offset compensator, and determining a distance between the light source and the target based on the offset corrected light beam output from the offset compensator and directed to a detector.

### BRIEF DESCRIPTION OF THE DRAWINGS

FIG. 1 illustrates an example light detection and ranging (LiDAR) system using a rotating polygon scanner and an offset compensator to correct for scanner-induced angular offset.

FIG. 2 illustrates an example rotating polygon scanner that induces angular offset and an offset compensator that corrects for the scanner-induced angular offset.

FIG. 3 illustrates an example prismatic offset compensator that corrects for scanner-induced angular offset.

FIG. 4 illustrates an example solid state phased array offset compensator that corrects for scanner-induced angular offset.

FIG. 5 illustrates another example offset compensator that corrects for scanner-induced angular offset.

FIG. 6 illustrates yet another example offset compensator that corrects for scanner-induced angular offset.

FIG. 7 illustrates example operations for operating a LiDAR system using a rotating polygon scanner and an offset compensator to measure distance to a target.

FIG. 8 illustrates an example system diagram of a computer system suitable for implementing a LiDAR system using a rotating polygon scanner and an offset compensator.

### DETAILED DESCRIPTION

In laser detection and ranging (LiDAR) systems, a number of points per second that a laser source can provide to a point cloud is typically limited by the maximum range a LiDAR system seeks to address as light takes a finite time to travel to a target and back. If round-trip travel time (RTT) of light to the LiDAR's maximum range is given by (max, then any pulse repetition rate that is less than tₘₐₓ introduces an ambiguity, as it will not be clear if the earlier pulse is returning from a distant target, or the later pulse is returning from a nearby target. It is generally true, then, that for a single source in a LiDAR system to generate points at a repetition rate greater than Imax, the LiDAR system must be able to distinguish between pulses that were fired within the time tₘₐₓ.

Further, a very large range of signals must be detectable and distinguishable by embedded LiDAR systems and associated electronics. A powerful pulse of light is sent out and travels outbound until it hits a target, and the target scatters the light in all directions. The LiDAR system detects only a fraction of this scattered light power that travels back to its detection optics. In this case, the power of the detected optical pulse is proportional to 1/R², where R is the distance to the target. In an example LiDAR system, target distance may range from 1 meter to 300 meters, resulting in a dynamic range for the power of approximately 10⁵. Furthermore, the example LiDAR system may detect targets at long ranges with reflectivity as low as 10% and ranging up to 100% reflective, which further increases the dynamic range by a factor of 10 (to approximately 10⁶). Additionally, in some applications the target surfaces are retroreflectors, which directly reflect the light back to the example LiDAR system rather than scattering in all directions. This can introduce extremely high-power return light power, which can further dramatically increase dynamic range. The 10⁶ (or more) dynamic range needed by the example LiDAR system can be difficult to process overall.

Such processing of scattered and/or reflected light is further complicated in an example LiDAR system using a rotating scanner, such as various implementations disclosed herein. Specifically, the example LiDAR systems disclosed herein may include a rotating optomechanical scanner, such as a rotating polygon scanner with mirror surfaces on its sides that reflect a laser beam from a laser source towards a target and receive the scattered and/or reflected light back from the target towards one or more detectors. Alternatively, or additionally, the rotating optomechanical scanner may be described as a fast galvo scanner, a micro-electronic mechanical systems (MEMS) scanner, a rotating prism scanner, etc. Rotational momentum of the scanner implies that its rotational motion continues while each optical pulse is in flight. While each optical pulse may take only a few micro-seconds to travel from a light source to a target and back to a detector, rotation of the scanner results in its mirror surfaces pointing in slightly different directions when a light pulse returns vs. when it was emitted from the laser source.

As a result, the scanner will reflect a pulse inbound to the example LiDAR system at a slightly different angle as compared to what was transmitted outbound, which is referred to herein as angle offset. Often this angle difference is fractions of a degree, but it may increase linearly with distance to the target. When this pulse is directed at a collection optic such as a lens, the optic will focus the pulse onto a detector. However, the lens also transforms the small angular offset into a positional offset on the detector face. This positional offset becomes larger as the range to the target increases. The magnitude of this positional offset is usually a few 10's to potentially a few 100's of microns in various implementations. In various LiDAR systems, particularly coherent LiDAR systems, the detector size may be much smaller than the positional offset. This may cause accuracy and reliability issues within the LiDAR system.

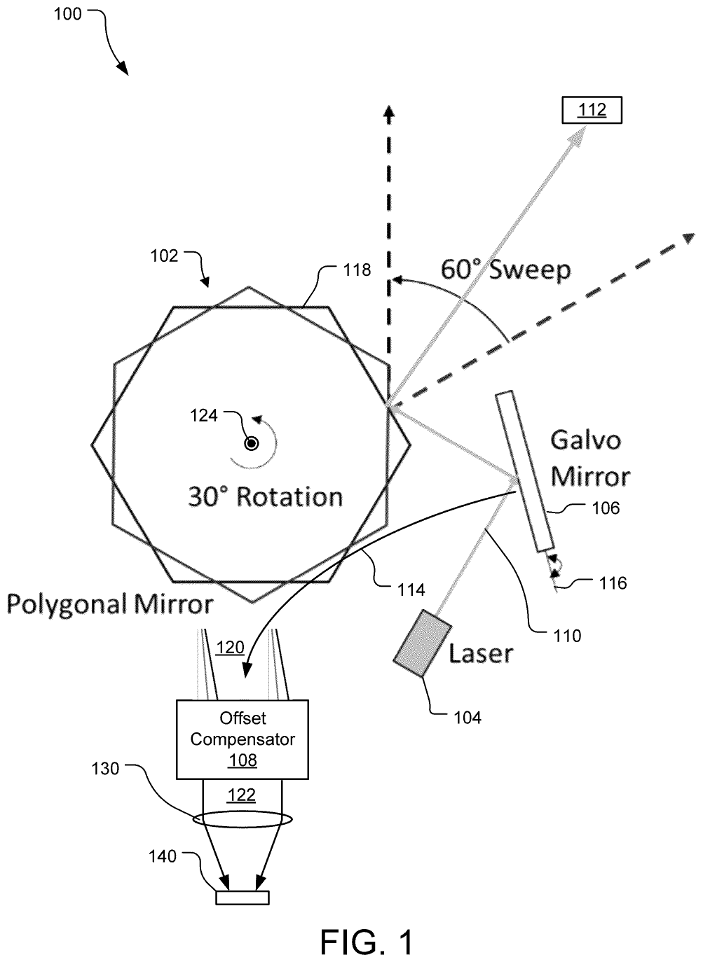

FIG. 1 illustrates an example light detection and ranging (LiDAR) system 100 using a rotating polygon scanner 102 and an offset compensator 108 to correct for scanner-induced offset. A light or laser source 104 (e.g., a laser diode or light-emitting diode (LED)) emits a beam of light or light beam 110 (e.g., infrared light) through emitter optics (collectively, one or more turning mirrors, galvo mirror 106, and rotating polygon scanner 102) to direct and focus the light on a target 112 (e.g., as an automobile in an autonomous automobile application). A portion of the beam of light is reflected from the target 112 and returned to the system 100 at detector optics 130, as illustrated by arrow 114. The detector optics 130 collect and focus the reflected light on detector 140 (e.g., an optical waveguide, an avalanche photodiode (APD), a multi-pixel photon counter (MPPC), and/or a PIN photodiode) that is used to measure a distance from the system 100 to the target 112.

The emitter optics cause the light beam 110 outbound from the laser 104 to be reflected from the galvo mirror 106 towards the rotating polygon scanner 102. The galvo mirror 106 may be installed on a pivoting assembly that permits it to rotate back and forth about galvo axis 116 that is oriented parallel to the plane of FIG. 1, thereby enabling a vertical scanning range for the system 100 (e.g., −10 degrees to +10 degrees). The rotating polygon scanner 102 may have mirror surfaces on each of its sides (e.g., side 118) and may rotate around scanner axis 124, which is oriented perpendicular to the plane of FIG. 1. This enables a horizontal scanning range for the system 100 equal to double the rotation of the scanner 102. For example, for the depicted six-sided polygon scanner 102, each side utilizes 30-degrees of rotation for the scanner 102. The system 100 achieves 60 degrees of horizontal scanning range. The rotation of the polygon scanner 102 together with the oscillation of the galvo mirror 106 allows the light generated by the laser 104 to scan the target 112 within a horizontal sweep (as depicted) of 60 degrees and a vertical scan (in and out of the plane of FIG. 1) of 20 degrees, for example. Other implementations may have different horizontal sweeping/or and vertical scanning ranges with similar applicability of the offset compensator 108 discussed below.

Using repeated distance measurements within the scanned field of view, the dual system 100 may build a complex map (also, point cloud) of the scanned field of view, including surfaces of target 112. More specifically, an array of raw distance measurements may be converted using a LiDAR image processor to create a 3D point cloud based on the array of raw distance measurements. This may be accomplished by directing the outbound beam of light in a scan pattern, using the detected reflections and corresponding distance measurements to create an image which captures the scanned field of view, including but not limited to the target 112 with detail, depth, and clarity.

The point cloud can then be further processed by a LiDAR image processor to provide a detailed sense of the scanned field of view, including shapes and distances to various targets, such as target 112, each of which may be changing over time. This may result in a successive series of point clouds that may be used in conjunction with a known position, speed, and direction of the system 100 to identify objects and their relative motion vectors and predict and avoid collisions between the system 100 and any identified targets.

The system 100 may also be used to make a digital 3-D representation of the target 112 by scanning an area and using the resulting array of calculated distances to the target 112 to map the target 112. Various applications of the ranging and 3-D representations created by the LiDAR system 100 include surveying, geodesy, geomatics, archaeology, geography, geology, geomorphology, seismology, forestry, atmospheric physics, laser guidance, airborne laser swath mapping (ALSM), and laser altimetry.

The light beam 110 generated by the laser 104 is reflected from the galvo mirror 106 and the polygon scanner 102 toward the target 112 within the sweeping/scanning range of the system 100. The light beam 110 is reflected from the object 112 and travels back toward the polygon scanner 102. Due to its angular rotation, the polygon scanner 102 induces a varying angle offset between the light reflected from the object 112 and the light beam 110 as it directs the light reflected from the object 112 back to the galvo mirror 106. The galvo mirror 106 directs the reflected light 120 onto the offset compensator 108, as illustrated by arrow 114. In general, the arrow 114 represents a direct reflection of light from the galvo mirror 106 onto the offset compensator 108, or a similar reflection with one or more turning mirrors oriented therebetween to direct the reflected light 120 to the offset compensator 108. Other implementations may utilize a different type of scanner system with a mechanical fast axis scanner (e.g., a pair of galvo mirrors where one of them is resonant and fast, a polygon scanner with a laser/detector array, a galvo mirrors with a laser/detector array, etc.) with offset compensation similar to that discussed in detail below.

The offset compensator 108 receives the inbound light beam and outputs an offset corrected light beam that reduces or eliminates the angular offset. In various implementations, the offset compensator 108 includes one or more of a prism, a scanner, a de-scanner, a local oscillator, an optical mixer, optical phased array controller, and a beam splitter. The offset compensated light 122 is directed to a collection lens 130, which in turn focuses the offset compensated light 122 on a detector 140 that includes one or more optical waveguides and/or photodiodes that is used to measure a distance from the system 100 to the target 112.

Measuring a distance from the system 100 to the target 112 may be accomplished using a ToF (direct or indirect) or a coherent LiDAR detection scheme. In an example direct ToF detection scheme, the light source 104 emits short pulses of light (e.g., several nanoseconds long) and the timing circuit measures the time until each pulse returns to the detector 140 to measure a distance to the target 112. In an example indirect ToF detection scheme, the light source 104 emits a continuous wave of modulated light. The detector 140 detects any reflected light from the target 112, and the timing of the reflected light (and in some implementations, differences in wavelength) are used to calculate a distance to the target. The outbound light may further include a pattern encoded on its phase (or frequency or amplitude) and then that pattern is recovered in detection of the inbound light and used to determine the distance to the target.

In coherent LiDAR, the laser 104 may be a low power frequency modulated continuous wave (FMCW) laser source, or other laser source capable of frequency and/or phase modulation. In some implementations, the phase modulation is done external to the laser 104 source, while the frequency modulation is done within the laser 104 source itself. The detector 140 is capable of detecting the modulation of the offset corrected light beam. Coherent LiDAR is capable of measuring radial velocity of reflected light from the target 112 directly, has quantum-limited sensitivity, and is less susceptible to interference than ToF LiDAR. Two example modulation formats of coherent LiDAR are linear frequency modulation (LFM) and phase shift keying (PSK, phase-coded LiDAR).

In coherent LiDAR in particular, the scanner-induced angle offset makes operation difficult. While ToF LiDAR can use a detector whose size is on the order of the positional offset induced by the angle offset beam, coherent LiDAR relies on the precise interference of a local oscillator laser beam with the returning laser beam. As a result, coherent LiDAR systems cannot tolerate positional offset that is much greater than the size of a single mode, which is often on the order of the wavelength of light generated by the light source 104 (e.g., a few microns). Because of this, while reducing the positional offset of the returning light may be useful in ToF LiDAR systems, it may be crucial in coherent LiDAR systems.

Additionally, the scanner-induced angle offset is not reduced without a trade-off. In physical optics, there is a Fourier relationship between the size of a light beam, and its angle of divergence. This broadly means that to reduce the angular spread in a laser beam by a given factor, its size is increased by that same factor. As a result, the system 100 may require a larger power output from the light source 104 than a similar system that omits the offset compensator 108. Regardless of which detection scheme the system 100 utilizes, precise measurement of the reflection timing (and phase) with the needed accuracy and resolution, particularly for autonomous vehicles, is difficult. The offset compensator 108 increases accuracy and resolution of distance measurement between the system 100 and the target 112 at the expense of additional power consumed by the light source 104 and overall complexity of the system 100.

The system 100 as contemplated herein includes one or both of emitter optics and detector optics, some components of which may be shared between the emitter optics and detector optics, as illustrated in FIG. 1. For example, the emitter optics include the galvo mirror 106 and the polygonal mirror 102, while the detector optics also include the galvo mirror 106 and the polygonal mirror 102, and additionally the collection lens 130. Accordingly, the entire optics assembly for the system 100 includes the galvo mirror 106, the polygonal mirror 102, collection lens 130, and all turning mirrors, windows, filters, and lenses. Further implementations may include additional optical components (e.g., turning mirrors, windows, filters, and lenses) within one or both of the emitter optics and the detector optics.

While a single channel LiDAR system 100 is illustrated in FIG. 1 and described above, other implementations may include additional channels with similar corresponding light source(s), optic(s), offset compensator(s), and detector(s). Some components may be shared between multiple channels (e.g., the polygonal mirror 102 may be shared between a two-channel LiDAR system).

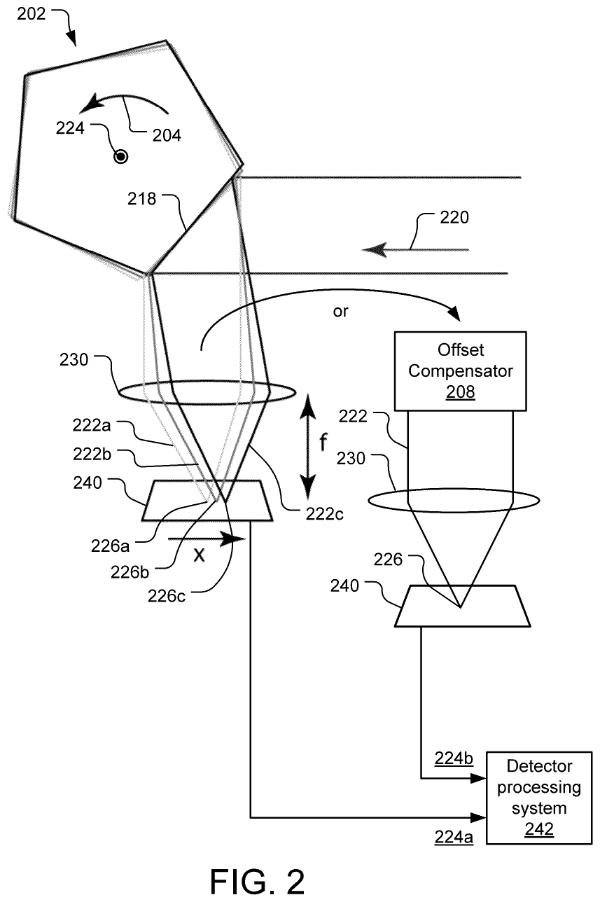

FIG. 2 illustrates an example rotating polygon scanner 202 that induces angular offset and an offset compensator 208 that corrects for the scanner-induced angular offset. The rotating polygon scanner 202 rotates around its axis 224 in direction 204. Light 220 reflected from one or more targets (not shown) at different instances in time may find a reflecting surface 218 of the scanner 202 at slightly different angles due to a constant rotation of the scanner 202.

For example, the light signal 220 reflected from the surface 218 at Moment A may be focused by lens 230 on detector 240 at focal point 226a, as illustrated by focused light beam 222a. However, the light signal 220 reflected from the surface 218 at Moment B, with Moment B being slightly later in time compared to Moment A, may be focused by lens 230 on detector 240 at focal point 226b, as illustrated by focused light beam 222b. Similarly, the light signal 220 reflected from the surface 218 at Moment C, with Moment C being slightly later in time compared to Moment B, may be focused by lens 230 on detector 240 at focal point 226c, as illustrated by focused light beam 222c. This angular offset yields a progression in focal point position on the detector 240 in direction x, which may be referred to herein as positional offset on the detector face. In some implementations, the positional offset on the detector face may be 10s or 100s of microns (e.g., approximately 60 microns). The variance of focal point position on the detector 240 affects the overall accuracy of the detector 240.

In sum, the rotational movement of the scanner 202 results in the reflected light beam 220 being focused at different points on the detector 240 over time, thus allowing the light received at different times being disambiguated from each other. As the time for the reflected beam 220 impinging on the scanner surface 218 depends on distance of the target that it is being reflected from, this disambiguation in effect allows disambiguating between reflected light being received from targets at different distances. Such lateral motion (x) of the received light on the detector 240 depends on the various factors including focal length (f) of the lens 230, the time delay (t) experienced by the reflected light 220 in transit to and from the target, and rotational speed (ω) of the scanner 202. For example, for an f of 20 mm, ω of 240 radians/second, and t of 2 μs, the lateral displacement (positional offset) may be given by x=60.3 μm.

Alternatively, the light 220 reflected from the target(s) at different instances in time may be directed from the reflecting surface 218 of the scanner 202 at slightly different angles into an offset compensator 208. The offset compensator 208 receives the inbound light beam with a variable angular offset and outputs an offset corrected light beam 222 that reduces or eliminates the angular offset. The reduced angular offset yields a positional offset of the detector 240 of less than 5 microns (or less than 3 microns). In coherent LiDAR applications where an optical waveguide is provided on the detector 240 to channel the light, the offset corrected light beam 222 may only adequately couple to the optical waveguide if the positional offset on the detector 240 is less than 5 microns (or less than 3 microns).

In various implementations, the offset compensator 208 includes one or more of a prism, a scanner, a de-scanner, a local oscillator, an optical mixer, optical phased array controller, and a beam splitter. The offset compensated light beam 222 is directed to the collection lens 230, which in turn focuses the offset compensated light beam 222 on the detector 240. The detector 240 includes one or more optical waveguides and/or photodiodes, such as avalanche photodiodes (APDs), that are used to measure distance to a target.

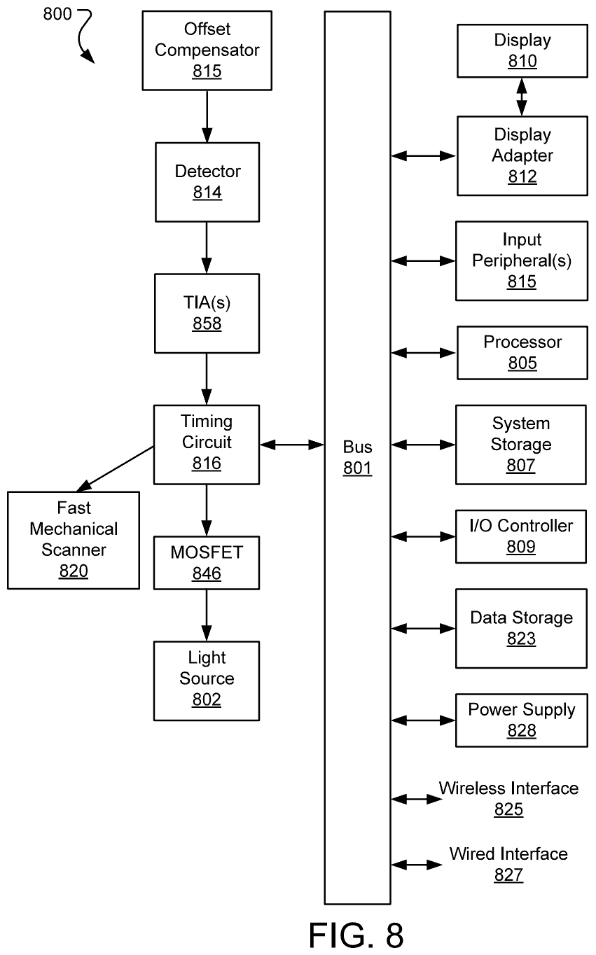

Other types of photodiodes, with or without optical waveguides, may be used and the selection of the type of photodiodes may depend on the frequency of the transmitted light as well as the frequency of the light received at the detector 240. Output 224a or 224b from the detector 240 is input to a detector processing system 242 (e.g., a computing system, such as computing system 800 discussed in detail below with reference to FIG. 8) to calculate distance(s) to one or more targets.

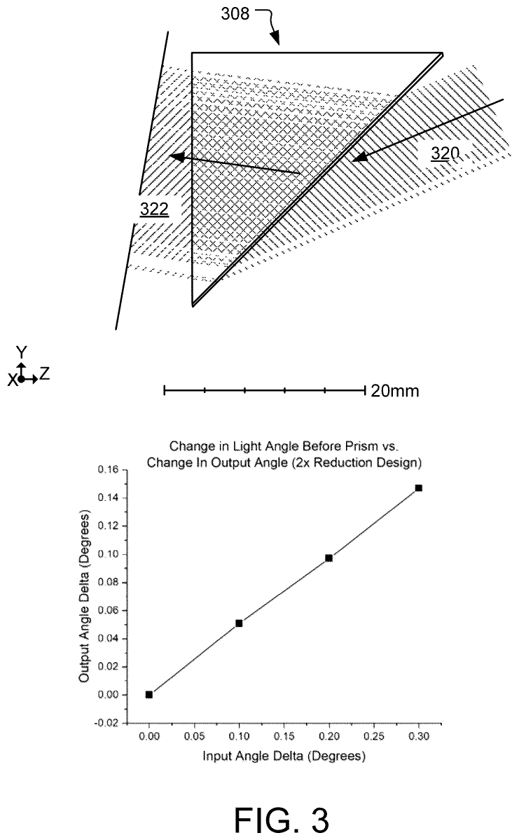

FIG. 3 illustrates an example prismatic offset compensator 308 that corrects for scanner-induced angular offset. The prismatic offset compensator 308 includes a prism that is specifically tuned to function as a periscope to direct an inbound light beam 320 toward a detector and proportionally reduce angular offset of the inbound light beam 320. Specifically, the inbound light beam 320 is reflected from a target and directed from a reflecting surface of a rotating polygon scanner at slightly different angles over time into the prismatic offset compensator 308. The prism proportionally bends the inbound light beam 320 toward the detector. Specifically, as an inbound light beam impacts the prism at increasing angular offsets, the prism increasingly corrects toward the detector.

The offset compensator 308 receives the inbound light beam 320 with a variable angular offset and outputs an offset corrected light beam 322 that reduces the angular offset. When the light impinges on the prism at a large enough angle, it will refract at a different angle and the effective size of the light beam will change, as illustrated in FIG. 3. This corrected light beam 322 then exits an opposing angled face of the prism. The prism angle is set such that the size of the corrected light beam 322 is increased relative to the inbound light beam 320, and the angle offset of corrected light beam 322 is reduced by the same value. Therefore, the corrected light beam 322 reaches a collection lens with a reduced angular offset. This, in turn, reduces the positional offset across the face of the detector. This allows a coherent LiDAR with a fast mechanical scanner to become easier to implement.

The prismatic offset compensator 308 is made of glass or optical-grade plastic and is mechanically suspended within a path of the inbound light beam 320 between the rotating polygon scanner and the collection lens. The prism geometry is calculated according to Snell's law to achieve a desired angular offset correction factor. More specifically, the prism is designed to be sufficiently large to magnify the inbound light beam 320 by the amount that it reduces the angle by (for example, at least 2× size of the inbound light beam 320 to reduce the angle lag by factor of 2×). In addition, the output angle (theta) is related to the input angle (phi) and the prism angle (th_p) by applying Snell's law:

sin(theta)=n*sin(pi/2-th_p+arcsin(sin(phi)/n)).

The angles at which the derivative of the above expression is 0.5 (or another desired angle offset reduction) are used.

An example correction factor of 2 for the offset compensator 308 is illustrated. Specifically, the actual input angle is referenced against a desired input angle and is provided as a difference or delta between the two along a singular axis (this difference being referred to herein as angular offset). The output angle is shown to be reduced by a correction factor of 2. For example, for the inbound light beam 320 having an angular offset of 0.10, the corrected light beam 322 only has an angular offset of 0.05; for the inbound light beam 320 having an angular offset of 0.20, the corrected light beam 322 only has an angular offset of 0.10; and so on. As the prismatic offset compensator 308 is purely optical and functions proportionally to reduce the angular offset, it merely reduces but does not eliminate the angular offset.

The offset corrected light beam 322 is directed to the collection lens, which in turn focuses the offset corrected light beam 322 on the detector. The detector includes one or more optical waveguides and/or photodiodes that is used to measure distance to the target. Refraction of light within the prismatic offset compensator 308 enables beam shaping in a single dimension, and this is desirable in LiDAR systems with a fast-scanning element, such as that illustrated in FIGS. 1-2 and described in detail above.

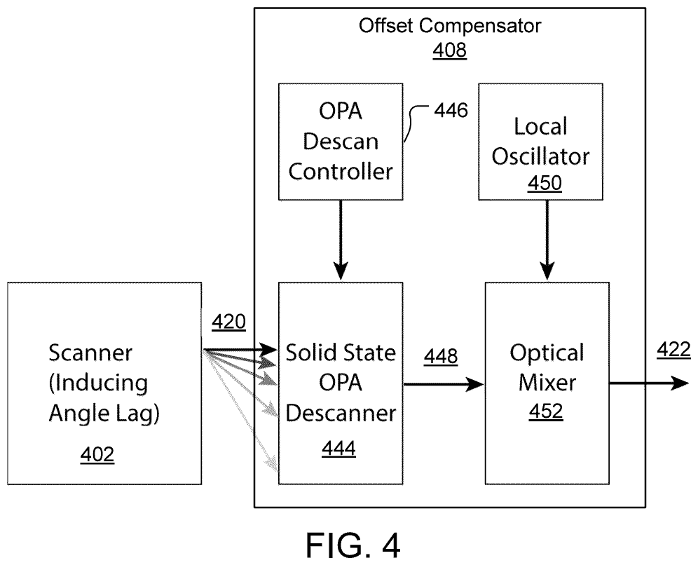

FIG. 4 illustrates an example solid state phased array offset compensator 408 that corrects for scanner-induced angular offset. The phased array offset compensator 408 includes a solid-state phased array scanner (also referred to as an optical phased array) that has no moving parts. The phased array offset compensator 408 functions by changing the relative phase delay between different sections of an inbound light beam 420, which can cause the direction of the inbound light beam 420 to change to a more uniform offset corrected light beam 422 that has a reduced or eliminated angle offset. Such arrays are typically more feasible over a small range of angles (e.g., 0.1-0.3 degrees) than a large range (e.g., 10's-100 degrees), which is aligned with a similarly small range of expected angle offsets contemplated herein.

Specifically, the inbound light beam 420 is reflected from a target and directed from a reflecting surface of a rotating polygon scanner 402 at slightly different angles over time into the phased array offset compensator 408. The solid-state phased array scanner causes the inbound light beam 420 to angle toward the detector (not shown). Specifically, as the inbound light beam 420 impacts the solid-state phased array scanner at increasing angular offsets, the solid-state phased array scanner increasingly corrects toward the detector.

The phased array offset compensator 408 is illustrated as a solid-state optical phased array (SSOPA) chip that de-scans the angle lag induced by the mechanical scanner 402 using a SSOPA de-scanner 444. A de-scan controller 446 uses timing-based circuitry to tell the phased array offset compensator 408 how much to de-scan, by for example, matching its angle scanning with the anticipated angle lag at a given moment in time. The result is a single-angle laser beam 448 that can be mixed with a local oscillator 450 in an optical mixer 452 to output the offset corrected light beam 422 for detection by the detector. In various implementations, the SSOPA chip could be transmissive or reflective depending on the performance and packaging requirements.

The offset corrected light beam 422 is directed to a collection lens, which in turn focuses the offset corrected light beam 422 on the detector with a reduced or eliminated angular offset. This, in turn, reduces or eliminates the positional offset across the face of the detector. The detector includes one or more optical waveguides and/or photodiodes that is used to measure distance to the target.

The phased array offset compensator 408 may be used to counteract scanner-induced angle offset from various mechanically scanned LiDAR systems where the angle offset is 0.1-0.2 degrees (e.g., to de-scan the return light and/or to scan the local oscillator to match the return light). The optical phased array (OPA) can either be reflecting or transmitting. In addition, because the phased array offset compensator 408 aligns the local oscillator 450 with the light beam 448, the phased array offset compensator 408 may be placed in an optical path to either scan the local oscillator to match the corrected light, or it can de-scan the corrected light to keep it from scanning across the detector face. The phased array offset compensator 408 then solves the angle lag problem by producing its own counteracting angle for the offset corrected light beam 422.

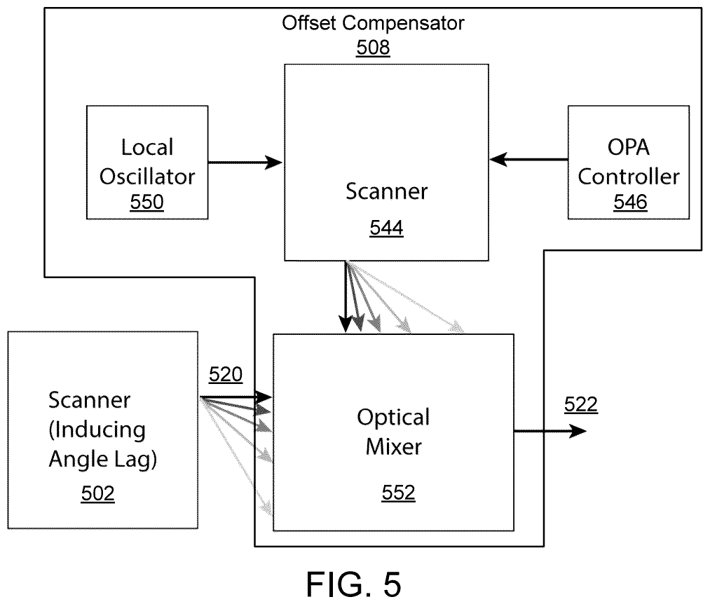

FIG. 5 illustrates another example offset compensator 508 that corrects for scanner-induced angular offset. In some implementations, the offset compensator 508 includes a solid-state phased array scanner 544 (also referred to as an optical phased array (OPA)) that has no moving parts. In other implementations, the offset compensator 508 includes a microelectromechanical (MEMS) scanner 544. The offset compensator 508 functions by changing the relative phase delay between different sections of an inbound light beam 520, which can cause the direction of the inbound light beam 520 to change to a more uniform offset corrected light beam 522 that has a reduced or eliminated angle offset. Such arrays are typically more effective over a small range of angles (e.g., 0.1-0.3 degrees) than a large range (e.g., 10's-100 degrees), which is aligned with a similarly small range of expected angle offsets contemplated herein.

Specifically, the inbound light beam 520 is reflected from a target and directed from a reflecting surface of a rotating polygon scanner 502 at slightly different angles over time into the offset compensator 508. The offset compensator 508 causes the inbound light beam 520 to angle toward the detector (not shown). Specifically, as the inbound light beam 520 impacts the offset compensator 508 at increasing angular offsets, the offset compensator 508 increasingly corrects toward the detector.

The offset compensator 508 is illustrated as a SSOPA chip with a OPA or MEMS scanner 544 that scans local oscillator 550 to match up with the inbound light beam 520. While an OPA scanner has the advantage of no moving parts, a MEMS scanner mechanically acts on the local oscillator 550 to align it with the inbound light beam 520. The MEMS scanner is small and fast (e.g., stepwise movements taking approximately 1 microsecond), which is achievable for a small enough MEMS mirror.

As compared to the phased array offset compensator 408 of FIG. 4, the compensator 508 has the advantage that optical losses induced by scanner 544 will be paid by the local oscillator 550, which can be controlled (using controller 546) rather than the inbound light beam 520. Depending upon how far away the target is, the inbound light beam 520 may not be able to afford any additional losses. Optical mixer 552 combines the inbound light beam 520 with the signal from the scanner 544 to output the offset corrected light beam 522 for detection by the detector. The offset corrected light beam 522 is directed to a collection lens, which in turn focuses the offset corrected light beam 522 on the detector with a reduced or eliminated angular offset. This, in turn, reduces or eliminates the positional offset across the face of the detector. The detector includes one or more optical waveguides and/or photodiodes that is used to measure distance to the target.

The offset compensator 508 may be used to counteract scanner-induced angle offset from various mechanically scanned LiDAR systems where the angle offset is 0.1-0.2 degrees (e.g., to de-scan the return light and/or to scan the local oscillator to match the return light). In addition, because the offset compensator 508 aligns the local oscillator 550 with the light beam 548, the offset compensator 508 may be placed in an optical path to either scan the local oscillator to match the corrected light, or it can de-scan the corrected light to keep it from scanning across the detector face. The offset compensator 508 then solves the angle lag problem by producing its own counteracting angle for the offset corrected light beam 522.

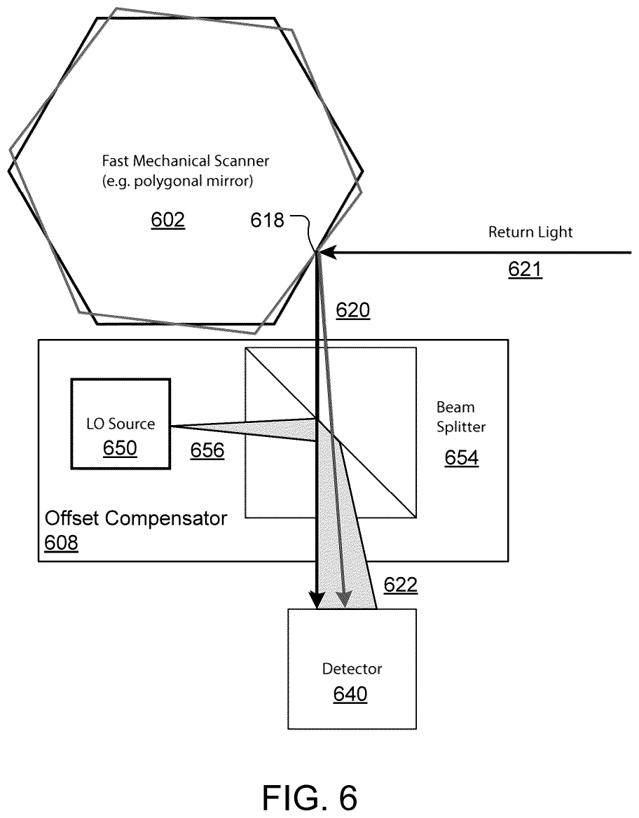

FIG. 6 illustrates yet another example offset compensator 608 that corrects for scanner-induced angular offset. Return light 621 is reflected from a target (not shown) and directed from a reflecting surface 618 of a fast mechanical scanner (or rotating polygon scanner) 602 as an inbound light beam 620 at slightly different angles over time into the offset compensator 608. The offset compensator 608 includes a local oscillator (LO source) 650 and a beam splitter and/or combiner 654. The local oscillator 650 outputs a local oscillator light beam 656 that is diverging to match the angle lag that fast mechanical scanner 602 introduces. The beam splitter 654 puts the diverging local oscillator light beam 656 and an inbound light beam 620 on an intersecting optical path. Detector 640 is sufficiently sized to accept light from any possible angles that the inbound light beam 620 has using an offset corrected light beam 622 output from the beam splitter 654.

The offset compensator 608 counteracts the angular offset or lag induced by the scanner 602 by matching the potential angular spread by diverging the local oscillator 650 by the same amount. By increasing the angles on the local oscillator wavefront, the wavefront of the offset corrected light beam 622 will match that of some portion of the local oscillator light beam 656. A large (e.g., ˜100 micron) detector 640 can then be used to collect local oscillator light beam 656 and the inbound light beam 620 combined as the offset corrected light beam 622. A disadvantage of this approach is that overall signal-to-noise ratio (SNR) decreases because some portion of the local oscillator light beam 656 will contribute to increased noise without contributing to amplifying the offset corrected light beam 622. However, this penalty can be thought of as part of the cost of using the fast mechanical scanner 602, which is the origin of the angular offset.

As discussed above, the local oscillator light beam 656 intersects the inbound light beam 620, which has a variable angle offset at the beam splitter 654. The beam splitter 654 is positioned such that the inbound light beam 620 has its wavefront relatively in line with that of the local oscillator light beam 656. However, the inbound light beam 620 wavefront can take on a multitude of angles depending on target distance, which means that a static flat wavefront on the local oscillator light beam 656 may be insufficient. A curved wavefront on the local oscillator light beam 656 can have at least a portion in line with the inbound light beam 620 as it changes, and a curved wavefront implies a converging or diverging beam of light. By diverging the local oscillator light beam 656, the offset compensator 608 detects targets within a predetermined range regardless of the scanner-induced angle offset.

The diverging local oscillator light beam 656 intersects multiple return angles of the inbound light beam 620 induced by scanner lag. The local oscillator source is set to diverge and encompass the entirety of the scanner induced angle offset. Therefore, the inbound light beam 620 wavefront is in line with the local oscillator light beam 656 wavefront regardless of scanner speed. In various implementations, the offset corrected light beam 622 is directed to a collection lens (not shown), which in turn focuses the offset corrected light beam 622 on the detector 640. The detector 640 includes one or more optical waveguides and/or photodiodes that is used to measure distance to the target.

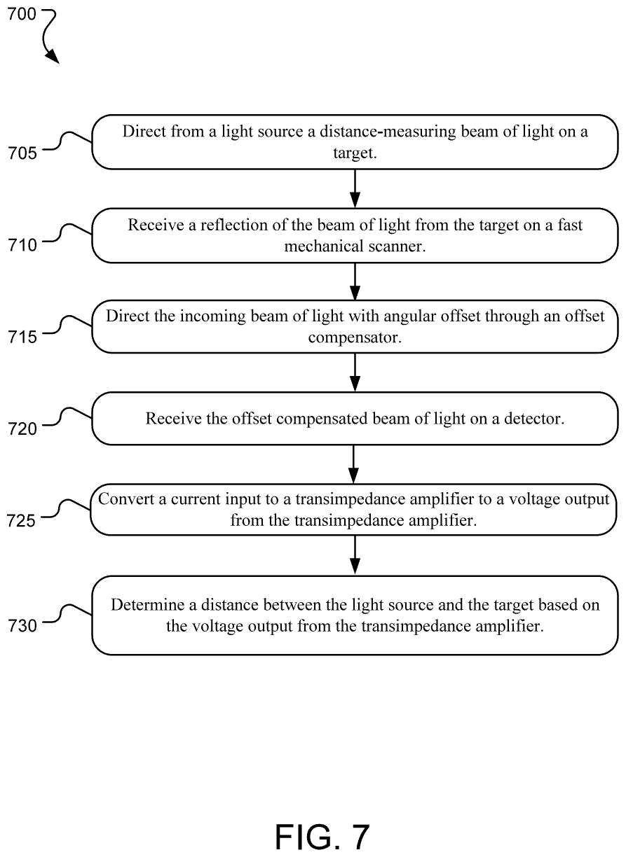

FIG. 7 illustrates example operations 700 for operating a LiDAR system using a rotating polygon scanner and an offset compensator to measure distance to a target. A directing operation 705 directs from a light source a distance-measuring beam of light on a target. The directing operation 705 may direct the light through a set of emitter optics within the Lidar system. A receiving operation 710 receives a reflection of the beam of light from the target on a fast mechanical scanner. The fast mechanical scanner induces an angular offset on the incoming beam of light as it spins.

A directing operation 715 directs the incoming beam of light with angular offset through an offset compensator. The offset compensator reduces or eliminates the angular offset of the incoming beam of light. In various implementations, the offset compensator includes one or more of a prism, a scanner, a de-scanner, a local oscillator, an optical mixer, optical phased array controller, and a beam splitter. A receiving operation 720 receives the offset compensated beam of light on a detector. The detector may include one or more optical waveguides and/or photodiodes. The receiving operation 720 may direct the light through a set of detector optics.

A converting operation 725 converts a current input to a transimpedance amplifier from the detector to a voltage output from the transimpedance amplifier. The timing circuit output(s) of the transimpedance amplifier(s) may also be connected to a timing circuit. A determining operation 730 determines a distance between the light source and the target based on the output of the detector as modified by the transimpedance amplifier using the timing circuit.

FIG. 8 illustrates an example system diagram of a computer system 800 suitable for implementing a LiDAR system using a fast mechanical scanner 820 and an offset compensator 815. The LiDAR system includes a light source 802 driven by a MOSFET 846 that receives a signal from a timing circuit 816 to fire the light source 802 at a predetermined frequency. The light source 802 emits a beam of light at a target (not shown) and portion of the beam of light is reflected from the target and returned to the fast mechanical scanner 820. The fast mechanical scanner 820 induces an angular offset on the incoming beam of light as it spins.

The incoming beam of light with angular offset through the offset compensator 815. The offset compensator 815 reduces or eliminates the angular offset of the incoming beam of light. In various implementations, the offset compensator includes one or more of a prism, a scanner, a de-scanner, a local oscillator, an optical mixer, optical phased array controller, and a beam splitter. The offset compensated beam of light is received on a detector 814. An output of the detector 814 is input to a transimpedance amplifier (TIA) 858 to convert and amplify the input current into a voltage useable by the timing circuit 816 to calculate a distance to the target.

The computer system 800 manages access to the timing circuit 816 and other components of the LiDAR system. The computer system 800 includes a bus 801, which interconnects major subsystems such as a processor 805, system storage 807 (such as random-access memory (RAM) and read-only memory (ROM)), an input/output (I/O) controller 809, removable storage (such as a memory card) 823, a power supply 828, and external devices such as a display screen 810 via a display adapter 812, and various input peripherals 815 (e.g., a mouse, trackpad, keyboard, touchscreen, joystick, and/or smart card acceptance device). Wireless interface 825 together with a wired network interface 827, may be used to interface to the data storage network and/or a local or wide area network (such as the Internet) using any network interface system known to those skilled in the art.

Many other devices or subsystems (not shown) may be connected in a similar manner (e.g., servers, personal computers, tablet computers, smart phones, mobile devices, etc.). Also, it is not necessary for all of the components depicted in FIG. 8 to be present to practice the presently disclosed technology. Furthermore, devices and components thereof may be interconnected in different ways from that shown in FIG. 8. Code (e.g., computer software, including mobile applications (apps) to implement the presently disclosed technology may be operably disposed in system storage 807 and/or data storage 823 (e.g., code for implementing the timing circuit 816 described in detail herein).

The computing system 800 may include a variety of tangible computer-readable storage media (e.g., the system storage 807 and the data storage 823) and intangible computer-readable communication signals. Tangible computer-readable storage can be embodied by any available media that can be accessed by the computing system 800 and includes both volatile and non-volatile storage media, as well as removable and non-removable storage media implemented in any method or technology for storage of information such as computer readable instructions, data structures, program modules, and/or other data. Tangible computer-readable storage media includes, but is not limited to, firmware, RAM, ROM, electrically erasable programmable read-only memory (EEPROM), flash memory or other memory technology, optical disc storage, magnetic cassettes, magnetic tape, magnetic disc storage or other magnetic storage devices, or any other tangible medium which can be used to store the desired information, and which can be accessed by the computing system 800.

Intangible computer-readable communication signals may embody computer readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, radio frequency (RF), infrared (IR), and other wireless media. Computer-readable storage media as defined herein specifically excludes intangible computer-readable communications signals.

Some implementations may comprise an article of manufacture which may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (APIs), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

Various implementations of the offset compensators described herein may be utilized separately or combined in a singular LiDAR system to achieve a desired level of angular offset compensation with acceptable increased complexity and potential losses.

The presently disclosed technology may be implemented as logical steps in one or more computer systems (e.g., as a sequence of processor-implemented steps executing in one or more computer systems and as interconnected machine or circuit modules within one or more computer systems). The implementation is a matter of choice, dependent on the performance requirements of the computer system implementing the presently disclosed technology. Accordingly, the logical operations making up implementations of the presently disclosed technology are referred to variously as operations, steps, objects, or modules. Furthermore, it should be understood that logical operations may be performed in any order, adding or replacing operations as desired, unless explicitly claimed otherwise or a specific order is inherently necessitated by the claim language.

The above specification, examples, and data provide a complete description of the structure and use of exemplary implementations of the presently disclosed technology. Since many implementations of the presently disclosed technology can be made without departing from the spirit and scope of the invention, the presently disclosed technology resides in the claims hereinafter appended. Furthermore, structural features of the different implementations may be combined in yet another implementation without departing from the recited claims.

What is claimed is:

1. A LIDAR device comprising:
a light source to direct an outbound light beam on a target;
a rotating optomechanical scanner to distribute the outbound light beam across a scanning range of the LiDAR device, the rotating optomechanical scanner further to receive an inbound light beam reflected from the target, wherein the optomechanical scanner induces an angular offset between the outbound light beam directed on the target and the inbound light beam reflected from the target;
an offset compensator to receive the inbound light beam and output an offset corrected light beam that reduces the angular offset; and
a detector including one or more photodiodes to receive the offset corrected light beam from the offset compensator.

2. The LiDAR device of claim 1, wherein the offset compensator includes a prism that functions as a periscope to direct the inbound light beam toward the detector and proportionally reduce the angular offset.

3. The LiDAR device of claim 2, wherein the prism reduces the angular offset of the inbound light beam by a factor of 2 or less.

4. The LiDAR device of claim 3, wherein the prism increases the size of the offset corrected light beam by the same factor of 2 or less.

5. The LiDAR device of claim 1, wherein the offset compensator includes a scanner that changes the relative phase delay between different sections of the inbound light beam.

6. The LiDAR device of claim 5, wherein the scanner substantially eliminates the angular offset of the inbound light beam.

7. The LiDAR device of claim 5, wherein the scanner eliminates 0.1-0.2 degrees of angular offset.

8. The LiDAR device of claim 5, wherein the offset compensator includes a de-scan controller to match its angle scanning with an anticipated angular offset at a moment in time.

9. The LiDAR device of claim 5, wherein the scanner is one of reflecting and transmitting.

10. The LiDAR device of claim 5, wherein the scanner includes an optical phased array scanning element.

11. The LiDAR device of claim 5, wherein the scanner includes a microelectromechanical scanning element.

12. The LiDAR device of claim 1, wherein the offset compensator includes a local oscillator to output a diverging oscillator light beam to match angular offset with the inbound light beam.

13. The LiDAR device of claim 12, wherein the offset compensator includes a beam splitter to put the diverging oscillator light beam and the inbound light beam on an intersecting optical path.

14. The LiDAR device of claim 1, wherein the light source is a modulated laser source, and the detector is capable of detecting a resulting modulation of the offset corrected light beam.

15. The LiDAR device of claim 1, wherein the reduced angular offset of the offset corrected light beam yields a positional offset on the detector of less than 5 microns.

16. The LiDAR device of claim 1, wherein the detector further includes an optical waveguide that directs the offset corrected light beam to the one or more photodiodes.

17. The LiDAR device of claim 16, wherein the offset corrected light beam couples to the optical waveguide with a positional offset on the detector of less than 5 microns.

18. The LiDAR device of claim 1, further comprising:
a lens configured to focus the offset corrected light beam on the detector.

19. The LiDAR device of claim 1, wherein the rotating optomechanical scanner is to distribute the outbound light beam across a horizontal scanning range of the LiDAR device, further comprising:
an oscillating galvo mirror to distribute the outbound light beam across a vertical scanning range of the LiDAR device.

20. The device of claim 1, wherein the one or more photodiodes are avalanche photodiodes.

21. The device of claim 1, wherein the rotating optomechanical scanner is one of a rotating polygon scanner, a MEMS scanner, a galvo scanner, and a rotating prism scanner.

22. The device of claim 1, further comprising:
a set of emitter optics to direct the outbound light beam from the light source to the target.

23. The device of claim 22, wherein the emitter optics include one or more turning mirrors, an oscillating galvo mirror, and a rotating polygonal mirror.

24. The device of claim 1, further comprising:
a set of detector optics to direct the outbound light beam reflected from the target to the detector.

25. The device of claim 1, further comprising:
a transimpedance amplifier, wherein a voltage output from the transimpedance amplifier is input to a timing circuit.

26. A method of operating a LiDAR system, the method comprising:
directing from a light source a distance-measuring beam of light on a target;
receiving a reflection of the beam of light from the target on a fast mechanical scanner;
compensating for angular offset induced by the fast mechanical scanner within the reflection of the beam of light using an offset compensator; and
determining a distance between the light source and the target based on the offset corrected light beam output from the offset compensator and directed to a detector.

27. The LiDAR device of claim 1, wherein the offset compensator includes:
a local oscillator to produce local-oscillator light; and
an optical mixer or optical combiner to combine the inbound light beam with the local-oscillator light, wherein the offset corrected light beam includes the inbound light beam and the local-oscillator light.
